(19) United States
(12) Patent Application Publication
(10) Pub. No.: US 2008/0080487 A1
(43) Pub. Date: Apr. 3, 2008

(54) Session initiation protocol trunk gateway apparatus

(75) Inventor: Atsushi Yamazaki, Hachioji-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/898,996

(22) Filed: Sep. 18, 2007

(30) Foreign Application Priority Data
Sep. 29, 2006 (JP) 2006-268262

(51) Int. Cl. H04L 12/66

(52) U.S. Cl. 370/352

(57) ABSTRACT

According to one embodiment, a session initiation protocol trunk gateway apparatus includes a register which registers each connection ID of the plurality of session initiation protocol terminals in a registration server on the session initiation protocol network at prescribed registration periods, a connector which connects among the plurality of session initiation protocol terminals and the session initiation protocol network, and a controller which divides the registration period into a plurality of distribution intervals in response to the number of the connection IDs, and executes registration processing of the next second connection ID with an interval by the distribution interval from registration start of a first connection ID among the plurality of connection IDs in registering the plurality of connection IDs in the registration server.

### CROSS-REFERENCE TO RELATED APPLICATIONS

This application is based upon and claims the benefit of priority from prior Japanese Patent Application No. 2006-268262, filed Sep. 29, 2006, the entire contents of which are incorporated herein by reference.

### BACKGROUND OF THE INVENTION

1. Field of the Invention

One embodiment of the present invention relates to a session initiation protocol (SIP) trunk gateway apparatus which connects among a plurality of SIP terminals each having communication functions defied by an SIP and an SIP network.

2. Description of the Related Art

In recent years, an Internet Protocol (IP) telephone system that interactively transmits and receives images and voice as packet data in real time via an IP network has become widely used. The IP telephone system can perform extension communications and outside-line originations or terminations among main apparatuses via the IP network as well as can perform inter-extension communications and outside-line originations and terminations for each main apparatus to be connected to the IP network. In the IP telephone system, the SIP as its protocol has become widely used.

In such a system, a URI (connection ID) of an SIP terminal for each main apparatus is registered in advance in a registration server of an agent on an SIP network, and when a SIP terminal makes a communication by the use of the SIP network, the registration server authenticates the SIP terminal based on the registered URI.

In the meantime, in the foregoing system, in registering URIs of a plurality of SIP terminals in the registration server on the SIP network, a single set of main apparatus exclusively occupies the SIP network, and the traffic on the SIP network becomes high, then, a processing load of the main apparatus in registration processing becomes high. As the number of sets of the SIP terminals accommodated in the main apparatus becomes large, this situation becomes conspicuous.

Conventionally, a method for performing load distribution in registration processing by shifting starting times of terminals by the use of a network management server has been taken into account (e.g., Jpn. Pat. Appln. KOKAI Publication No. 2006-42176).

However, in the aforementioned method, the registration server on the SIP network, such as a network management server, calculates the start timing of each SIP terminal, and in this case, increasing the number of the main apparatuses and of the SIP terminals results in an increase in processing load on the registration server in accordance with the extent of the increased number.

### BRIEF SUMMARY OF THE INVENTION

An object of the invention is to provide an SIP trunk gateway apparatus capable efficiently executing registration processing of each URI of a plurality of SIP terminals to a registration server on an SIP network while reducing a network load and a load necessary for registration processing.

According to an aspect of the present invention, there is provided a session initiation protocol trunk gateway apparatus which accommodates a plurality of session initiation protocol terminals each including communication functions defined with one another by session initiation protocols, and allows connecting a session initiation protocol network, comprising: a register which registers each connection ID of the plurality of session initiation protocol terminals in a registration server on the session initiation protocol network at prescribed registration periods; a connector which connects among the plurality of session initiation protocol terminals and the session initiation protocol network, to make communications among the plurality of session initiation protocols registered by the register and the session initiation protocol network; and a controller which divides the registration period into a plurality of distribution intervals in response to the number of the connection IDs, and executes registration processing of the next second connection ID with an interval by the distribution interval from registration start of a first connection ID among the plurality of connection IDs in registering the plurality of connection IDs in the registration server.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a preferred schematic configuration view of an IP telephone system regarding the first embodiment of the invention;

FIG. 2 is a preferred block diagram illustrating a functional configuration of a private branch exchange illustrated in FIG. 1;

FIG. 3 is a preferred view illustrating an example of each storage content of register control information table and a SIP-URI table shown in FIG. 2;

FIG. 4 is a preferred view for explaining a register transmission load distribution system regarding the first embodiment;

FIG. 5 is a preferred view for explaining a synchronous system inter-SIP-URI regarding the first embodiment;

FIG. 6 is a preferred view illustrating distribution interval counter inclement processing operations of a register control unit regarding the first embodiment;

FIG. 7 is a preferred view illustrating register start determination processing (first period) at the register control unit regarding the first embodiment;

FIG. 8 is a preferred view illustrating a register start determining processing (first period/end SIP-URI) of the register control unit regarding the first embodiment;

FIG. 9 is a preferred view illustrating register start determination processing (second period) of the register control unit regarding the first embodiment;

FIG. 10 is a preferred view illustrating register start determination processing (second period/end SIP-URI) of the register control unit regarding the first embodiment;

FIG. 11 is a preferred view illustrating register termination processing of the register control unit regarding the first embodiment; and

FIG. 12 is a preferred flowchart illustrating a control processing procedure of a register control unit as the second embodiment of the invention.

### DETAILED DESCRIPTION OF THE INVENTION

Various embodiments according to the invention will be described hereinafter with reference to the accompanying drawings.

### (First Embodiment

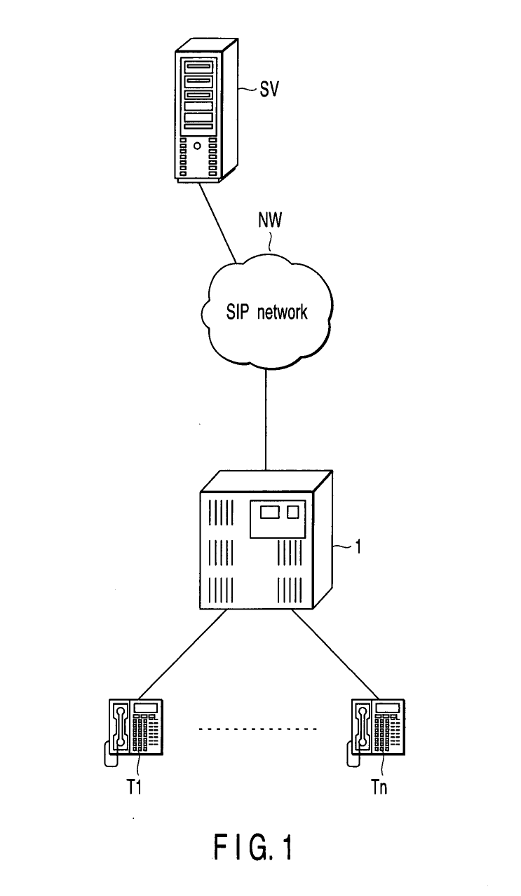

FIG. 1 is a preferred schematic configuration view of an IP telephone system regarding the first embodiment of the invention, and a numeral 1 indicates a private branch exchange apparatus as an SIP trunk gateway apparatus.

The exchange apparatus 1 accommodates a plurality of SIP terminals T1-Tn (n is natural number). A registration server SV is connected to the exchange apparatus 1 via an SIP network NW.

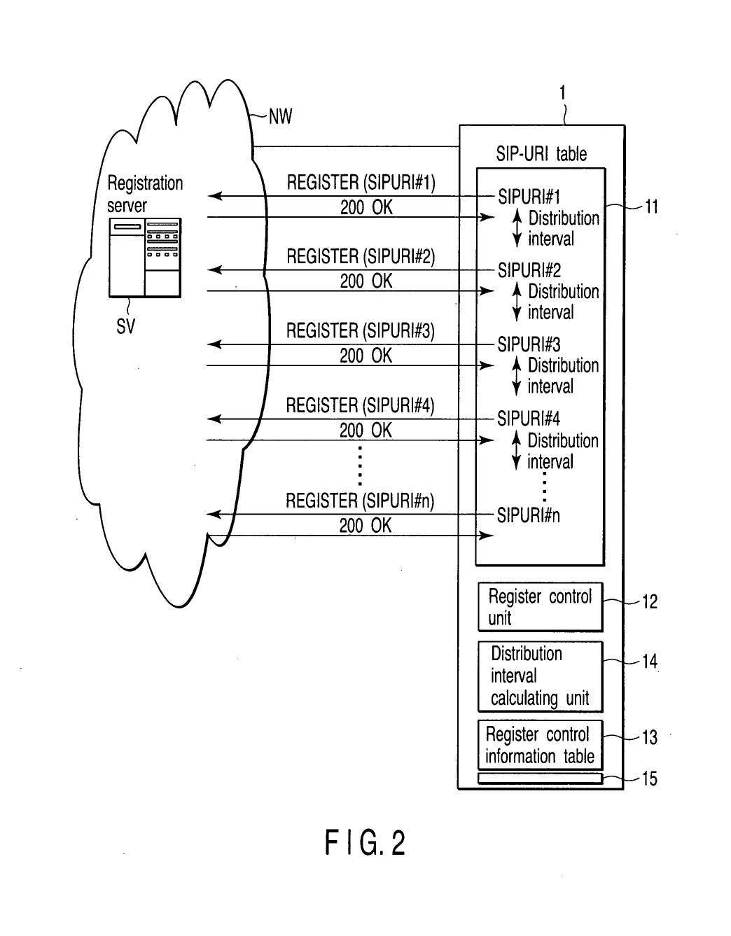

FIG. 2 is a block diagram depicting a functional configuration of the exchange apparatus 1.

The exchange apparatus 1 comprises an SIP-URI table 11 storing a plurality of SIP-URIs applied to each SIP terminal T1-Tn from a service provider of the SIP network NW; a register control unit 12 performing processing of registration of the SIP-URIs in a registration server SV on the SIP network NW; a register control information table 13 storing a variety of items of information necessary for registration processing (hereinafter referred to as table 13); a distribution interval calculating unit 14 calculating intervals to register the plurality of SIP-URIs (hereinafter referred to as calculating unit 14); and a timer 15.

In the exchange apparatus 1, the calculating unit 14 calculates distribution intervals from prescribes registration periods and the number of the SIP-URIs, and the control unit 12 transmits a REGISTER message in order to register the plurality of SIP-URIs in the registration server SV at these distribution intervals to the registration server SV on the SIP network NW.

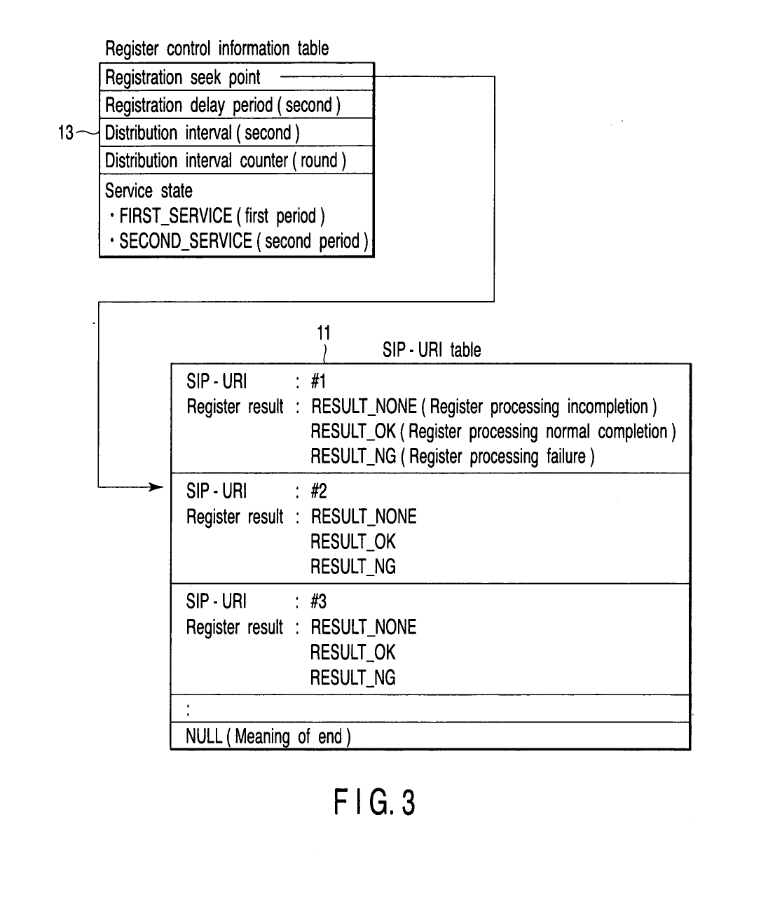

FIG. 3 depicts the table 13 and the SIP-URI table 11.

Control information for executing register processing is stored in the table 13. The plurality of SIP-URIs to be register execution objects are stored in the table 13.

A registration seek point in the table 13 is a pointer which indicates one SIP-URI entry in the SIP-URI table 11, and after registration processing termination of the corresponding SIP-URI, the seek point shifts to the next SIP-URI.

The distribution interval is calculated in accordance with the preset register period and the following equation at intervals to perform register processing of each SIP-URI calculated from the number of the SIP-URIs.

Distribution interval=(register period−registration delay time)/2/the number of SIP-URIs Equation

The distribution interval counter is a counter to measure the distribution intervals and receives timer termination notifications for every one second from the timer 15 to add them. The counter is zero-reset at every time of register processing completion of the SIP-URIs.

The registration delay period is a margin set so as to perform the next registration for a period slightly shorter than the register period so that a register time-out does not occur in the registration server SV.

A service state is control information for diving the register period into two periods, and FIRST_SERVICE indicates a first period, and SECOND_SERVICE indicates a second period.

Register results in the SIP-URI table 11 show results of register processing, RESULT_OK shows the fact of normal completion of the registration, RESULT_NG shows the fact of failure of the register processing, and RESULT_NONE shows the fact of incompletion of the register processing.

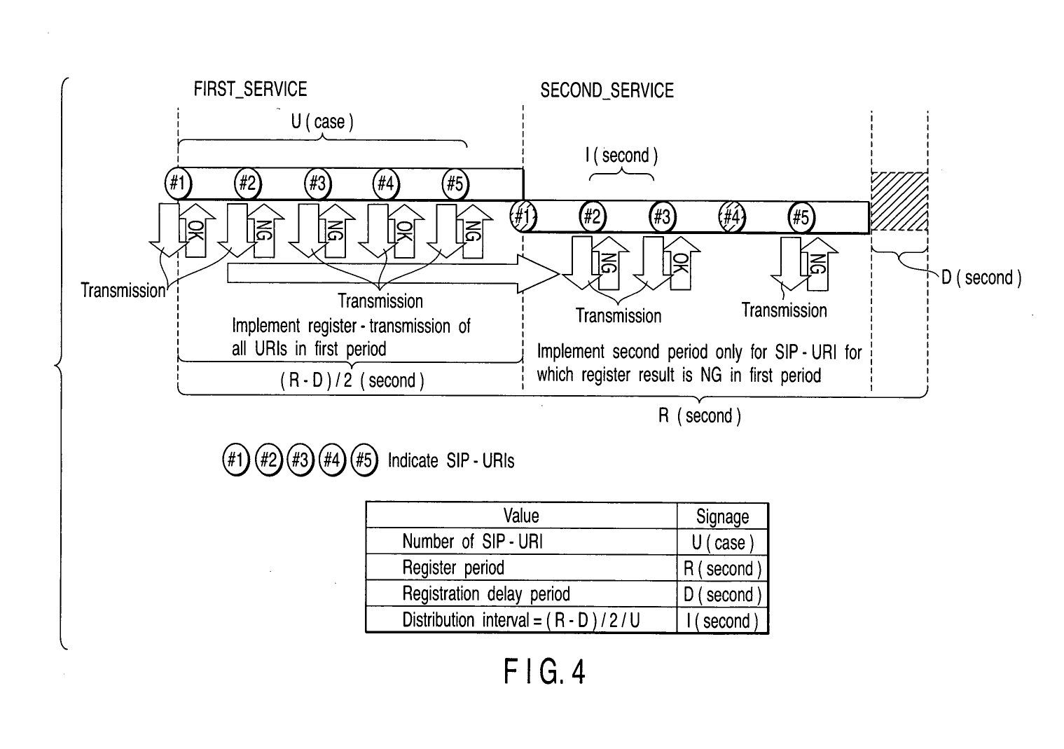

FIG. 4 shows a register transmission load distribution system.

It takes 32 seconds at a maximum from the transmission of one register message until the register result becomes clear in some cases.

Taking the case of occurrences of this time-lag at some SIP-URIs into account, the register period is divided into two periods of FIRST_SERVICE and SECOND_SERVICE. At this moment, a registration delay time is subtracted from the register period in advance in order to complete the register processing in a time slightly shorter than the register period so that the registration server SV does not pose register time-out.

Setting the value in which each period of divided two periods is divided by the number of SIP-URIs to the distribution interval, and setting each SIP-URI transmission interval to the distribution period achieve a load distribution of the register processing.

The system shown in FIG. 4 conducts register transmissions at distribution intervals for all SIP-URIs in the first period. In the second period, the system performs register transmissions at the same timing as that of the first period only for the SIP-URI of which the register processing has ended in failure in the first period. The register processing in the second period becomes able to relief the SIP-URI of which the register processing has resulted in failure in the second period.

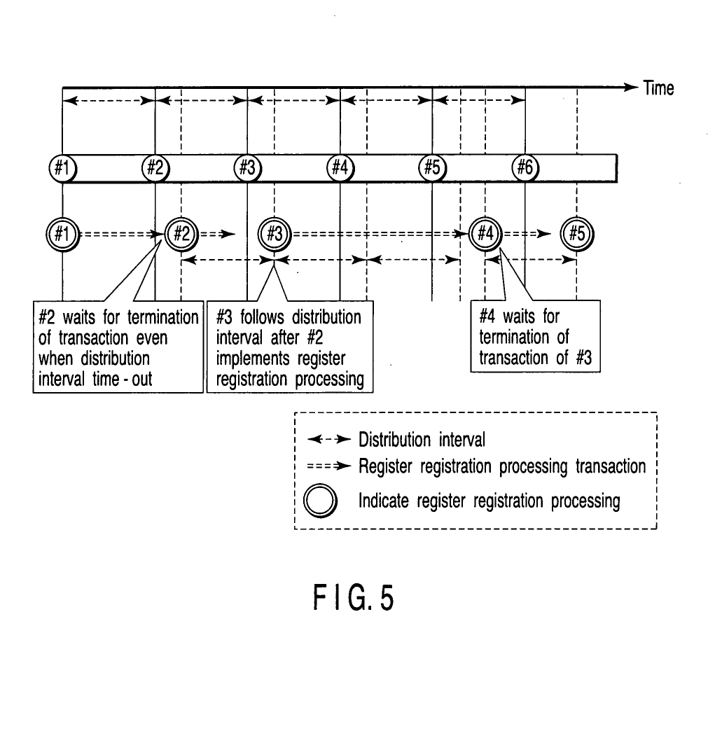

FIG. 5 depicts a synchronous system inter-SIP-URI.

As given above, since it takes 32 seconds at a maximum from the transmission of one register message until the register result becomes clear in some cases, even when the distribution interval is shorter than this maximum time, the system keeps the certainty of the load distribution by synchronizing the SIP-URIs so that the register processing of the next SIP-URI is not overlapped.

The system of FIG. 5 conducts the register processing of the next SIP-URI with a distribution interval after completing the register processing of a single SIP-URI.

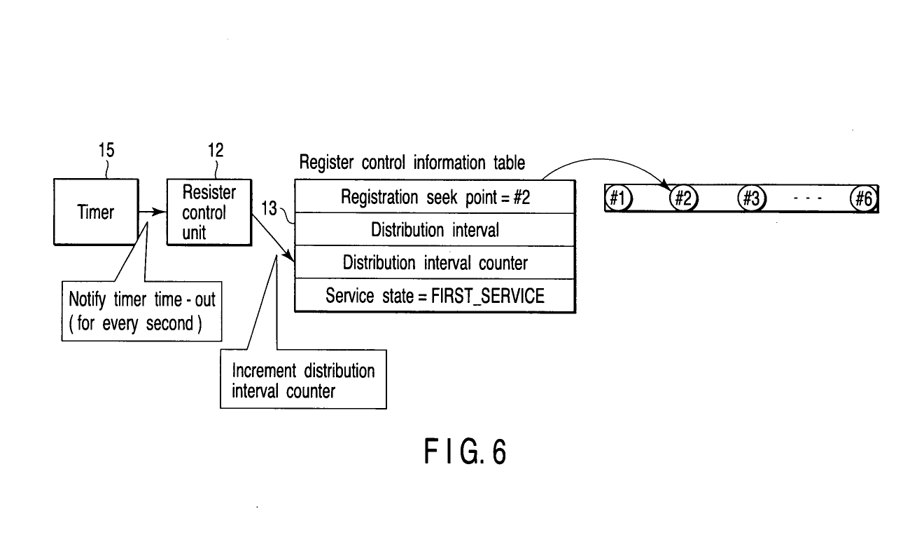

FIG. 6 illustrates distribution interval counter increment processing operations of the foregoing register control unit 12. The control unit 12 firstly receives timer termination notifications from the timer 15 for every one second.

When receiving the timer termination notification, the control unit 12 increments the distribution interval counter.

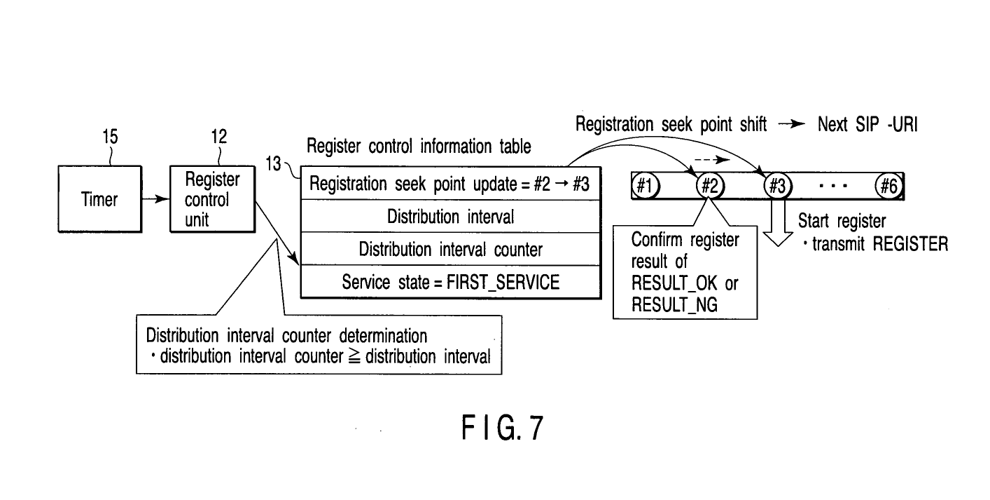

FIG. 7 shows a register start determination processing (first period) at the control unit 12.

After incrementing the interval counter in the processing of FIG. 6, the control unit 12 determines whether the value of the distribution interval counter is larger than that of the preset distribution interval.

If a formula, distribution interval counter≧distribution interval, is true, the control unit 12 determines whether or not the SIP-URI indicated by the registration seek point is currently in the middle of the register processing from the register result of the SIP-URI table 11.

If the SIP-URI is in the middle of the register processing (RESULT_NONE), the control unit 12 does not perform the register processing for the next SIP-URI so that the register processing does not overlap with each other.

Next to this, the control unit 12 confirms a service state, and if the service state is in FIRST_SERVICE, the control unit 12 carries out the following processing as processing in the first period.

In other words, the control unit 12 increments the registration seek point if the register processing has already completed (RESULT_OK or RESULT_NG) to start the register processing of the next SIP-URI. At this moment, the control unit 12 writes RESULT_NONE in the register result.

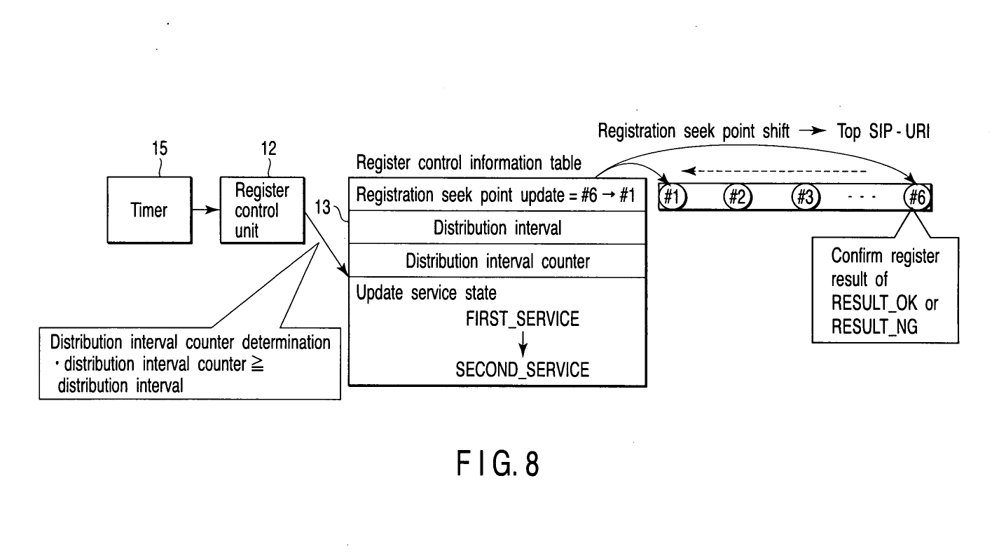

FIG. 8 depicts the register start determination processing (first period/end SIP-URI) at the control unit 12.

When the control unit 12 increments by one the registration seek point in the processing of FIG. 7, if the entry of the SIP-URI table 11 is NULL, the control unit 12 determines that the entry is end and shifts the registration seek point to the top SIP_URI. At this moment, the control unit 12 changes the service state from FIRST_SERVICE to SECOND_SERVICE.

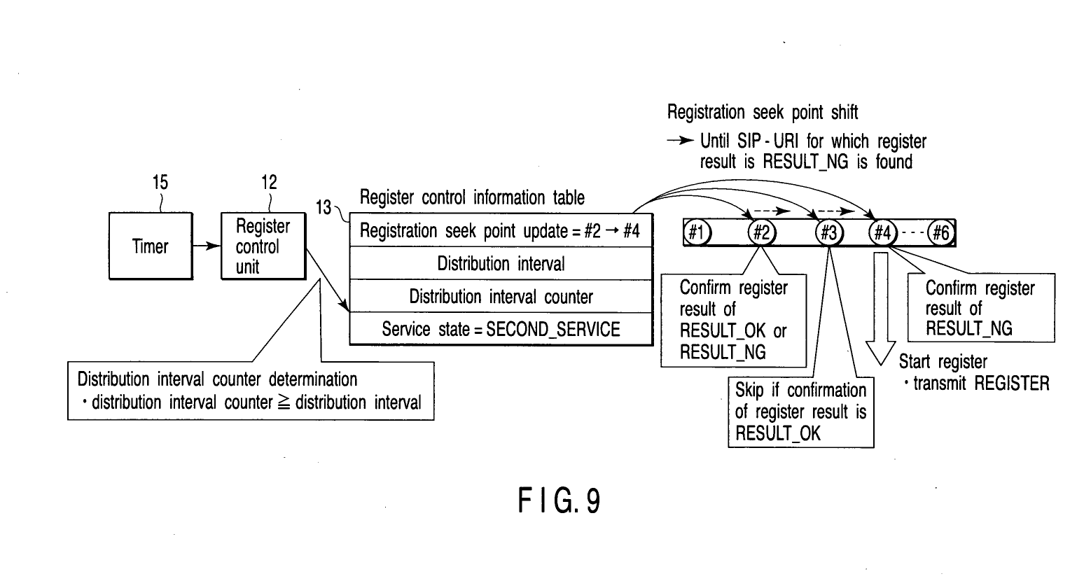

FIG. 9 illustrates register start determination processing (second period) at the control unit 12.

After incrementing the distribution interval counter in the processing of FIG. 6, the control unit 12 determines whether or not the value of the distribution interval counter is equal to that of the prescribed distribution interval or more.

If the formula, distribution interval counter≧distribution interval, is true, the control unit 12 determines whether or not the SIP-URI indicated by the registration seek point is now in register processing from the register result of the SIP-URI table 11.

If the SIP-URI is now in register processing (RESULT_NONE), the register processing of the next SIP-URI is not carried out so as not to overlap register processing with each other.

Next, the control unit 12 confirms a service state, and if the service state is in SECOND_SERVICE, the control unit 12 carries out the following processing as processing in the second period.

In other words, the control unit 12 advances the registration seek point until the SIP-URI, of which the register processing has already resulted in failure in the first period, namely of which the register result shows RESULT_NG, is found.

When finding out the SIP-URI, the control unit 12 starts the register processing. At this moment, the control unit 12 writes RESULT_NONE in the register result.

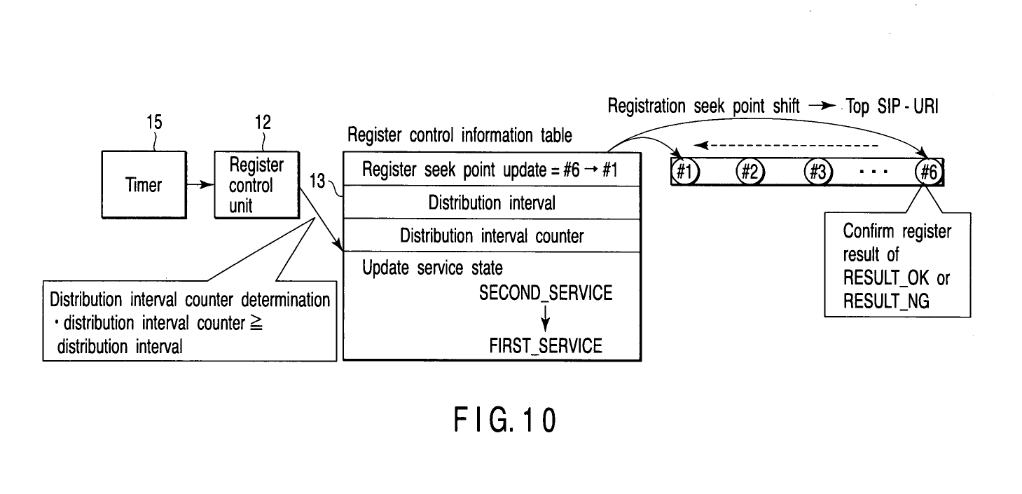

FIG. 10 shows register start determination processing (second period/end SIP-URI) of the control unit 12.

When incrementing by one the registration seek point in the processing in FIG. 9, if the entry to the table 11 is NULL, the control unit 12 determines that the seek point is at the end, and shifts the seek point to the top SIP-URI. At this time, the control unit 12 changes the service state from SECOND_SERVICE to FIRST_SERVICE.

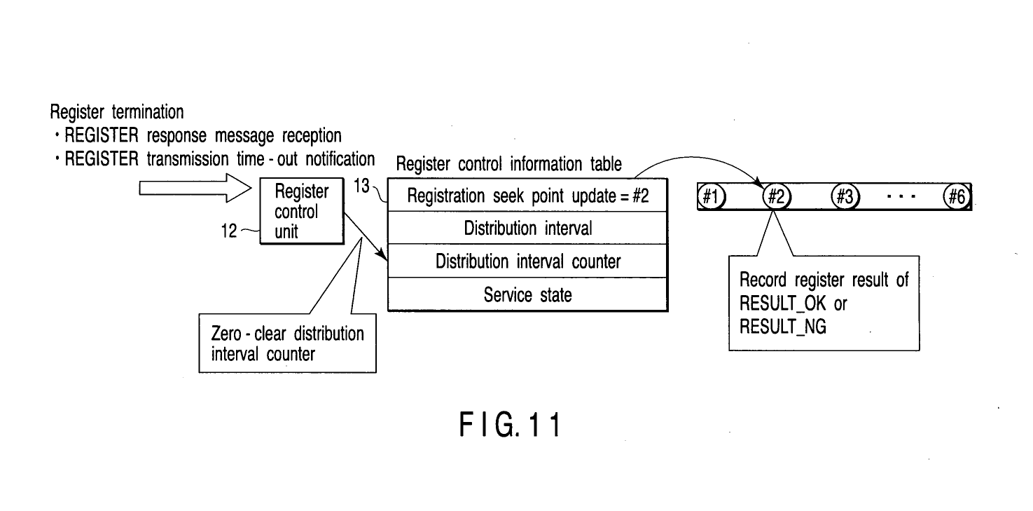

FIG. 11 depicts register termination processing at the control unit 12.

When receiving an event indicating a register termination, such as a REGISTER response message reception, and a REGISTER transmission time-out notification, the control unit 12 records a register result of RESULT_OK or RESULT_NG in the SIP-URI indicated by the registration seek point. The control unit 12 zero-clears the distribution interval counter.

As given above, in the private branch exchange apparatus 1 of the first embodiment, when registering a plurality of SIP-URIs in the registration server SV, a calculating unit 14 calculates distribution intervals from the number of SIP-URIs and registration periods registered in the SIP-URI table 11, the register control unit 12 performs the registration processing of the SIP-URIs of the SIP terminals T1-Tn at distribution intervals, then, the exchange apparatus 1 appropriates the time not in use within a time equivalent to the distribution interval to other processing, such as exchange processing and communication processing.

Accordingly, a single set of the exchange apparatus 1 does not exclusively occupy the SIP network NW so as to register a plurality of SIP-URIs in the server SV, therefore, the exchange apparatus 1 may distribute loads on the processing and network traffic required in registration. In the case of sharing of the SIP network NW with a large number of SIP terminals T1-Tn, its effective use rate may be enhanced.

In the first embodiment, since the register control unit 12 executes the registration processing of the next SIP-URI #3 after the completion of the registration processing of the SIP-URI #2, even when the time equivalent to the distribution interval lapsed from the registration start of the SIP-URI #2, the reliability in the registration processing can be enhanced.

Further, in the first embodiment, since the control unit 12 carries out the registration processing at distribution intervals by separating the registration period into FIRST_SERVICE and SECOND_SERVICE, the IP telephone system may register the SIP-URI, of which the registration has resulted in failure in FIRST_SERVICE, in SECOND_SERVICE, thereby, the system may improve the accuracy of the registration.

### Second Embodiment

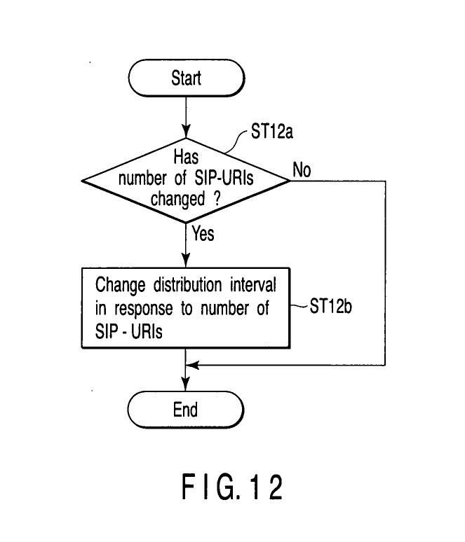

FIG. 12 is a flowchart illustrating a control processing procedure of the register control unit 12 as the second embodiment of the invention.

The control unit 12 firstly monitors each use situation of the accommodated SIP terminals T1-Tn, namely whether they are in activation or not (block ST12a), for example, if the SIP terminal T4 has changed its situation from being in activation to being in stoppage, the control unit 12 deletes the SIP-URI #4 of the SIP terminal T4 in the SIP-URI table 11 as well as notifies the SIP terminal 4 of which the situation has changed to the distribution interval calculating unit 14 (block ST12b).

Thus, the calculating unit 14 calculates the distribution interval by the number of SIP-URIs except for the SIP-URI #4 to register the calculation result in the table 13.

Even when the number of the SIP terminals to be registered increases, the control unit 12 carries out the same procedure as that described above.

As mentioned above, according to the second embodiment, the system may change the distribution interval to an optimum one in response to the addition or deletion of the number of the SIP terminals to be registered.

### Other Embodiment

The invention is not limited to each representative embodiment given above. In each embodiment, for example, the SIP gateway apparatus may be a terminal using a wireless LAN, or a software phone to be achieved by software on a personal computer so long as the gateway apparatus having a communication function defined by the SIP.

Other than this, a configuration and a type of an IP telephone system, a configuration and a type of an private branch exchange apparatus, a storage content on a register control information table, a calculation method and a registration control method of a registration time interval, etc., may be embodied in various forms without departing from the spirit or scope of the general inventive concept thereof.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A session initiation protocol trunk gateway apparatus which accommodates a plurality of session initiation protocol terminals each including communication functions defined with one another by session initiation protocols, and allows connecting a session initiation protocol network, comprising:
a register which registers each connection ID of the plurality of session initiation protocol terminals in a registration server on the session initiation protocol network at prescribed registration periods;
a connector which connects among the plurality of session initiation protocol terminals and the session initiation protocol network, to make communications among the plurality of session initiation protocols registered by the register and the session initiation protocol network; and
a controller which divides the registration period into a plurality of distribution intervals in response to the number of the connection IDs, and executes registration processing of the next second connection ID with an interval by the distribution interval from registration start of a first connection ID among the plurality of connection IDs in registering the plurality of connection IDs in the registration server.

2. The gateway apparatus according to claim 1, wherein
the controller executes registration processing of the second connection ID after completing registration processing of the first connection ID when the registration processing of the first connection ID even after a lapse of a time equivalent to the distribution interval from registration start of the first connection ID.

3. The gateway apparatus according to claim 1, wherein
the controller changes the distribution interval in response to an change in the number of connection IDs to be registered.

4. The gateway apparatus according to claim 1, wherein
the controller divides the registration period into a first period and a second period, and also divides the first and the second periods into a plurality of distribution intervals, respectively, in response to the number of the connection IDs, executes registration processing of the next second connection ID with an interval by the distribution interval from registration start of the first connection ID in the first period, and executes registration processing of a third connection ID of which the registration results in failure in the first period among the plurality of connection IDs at the distribution intervals in the second period.
